(19) United States
(12) Patent Application Publication
(10) Pub. No.: US 2006/0169108 A1
(43) Pub. Date: Aug. 3, 2006

(54) Barbed wire fastener and method for fastening the same

(76) Inventor: Nick L. Boone, Ames, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/047,407

(22) Filed: Jan. 31, 2005

(51) Int. Cl. B25B 13/06

(52) U.S. Cl. 81/121.1; 81/901

(57) ABSTRACT

A fastener for installing barbed wire having a helical shaped eye portion that is attached to a threaded shank. The eye portion having gaps and clearances that allow for barbed wire to be locked to a fence post and properly tightened. Additionally, a driving mechanism that has a specially designed slotted cavity that receives the eye portion of the barbed wire fastener for easy installation of the barbed wire to a fence post.

### BACKGROUND OF THE INVENTION

This invention is directed toward a fastener and driver for a barbed wire fence. More specifically, this invention is directed to an improved fastener for hanging barbed wire fencing, and a driver for use in mounting the fastener to a post.

Barbed wire strands are attached to support posts to provide fences for livestock and the like and to mark property boundaries. One way of connecting the wire strand to the support post is with U-shaped nails that straddle the strand and are driven into the post. The nails eventually work out of the post, particularly as the post decays and the nail must be replaced. Also, the nails require manual installation with a hammer which can be difficult when the wood hardens, and time consuming.

Metal support posts have also been used and most frequently are of a generally T-shaped cross sectional configuration with spaced guides to maintain the alignment of pearl strands making up a fence. These posts are more expensive to manufacture.

Thus, it is a primary object of the present invention to provide for an improved fastening device that allows for easy installation of traditional barbed wire.

Another object of the present invention is to provide for a barbed wire fastener that provides for a greater pull out force than conventional fasteners.

Another object of the present invention is to provide a barbed wire fastener that can be used in combination with a power tool that will receive the fastener and facilitate installation.

These and other objects, features, or advantages of the present invention will become apparent from the specification and claims.

### BRIEF SUMMARY OF THE INVENTION

A fastener for a barbed wire fence that has a threaded shank and a helically shaped eye portion that receives the barbed wire. The eye portion specifically is bent at a 45 degree angle from the center axis of the shank in order to facilitate the installation process and the tightening of the barbed wire. The fastener can be installed by using a driver mechanism that has an elongated shaft that is received by a power tool. The elongated shaft has an annular shoulder with a side wall that forms a slot or cavity that is specially shaped to receive the helically shaped eye portion of the barbed wire fastener. Thus, by using the driver with a power tool the barbed wire fastener may be driven into a fence post for easy installation of a barbed wire fence.

### BRIEF DESCRIPTION OF THE DRAWINGS

FIG. 1 is a perspective view of the barbed wire fastener and drive implement;

FIG. 2 is a top plan view of the eye portion of a fastener;

FIG. 3 is a side plan view of the barbed wire fastener; and

FIG. 4 is a sectional view of the driving mechanism.

### DESCRIPTION OF THE PREFERRED EMBODIMENTS OF THE INVENTION

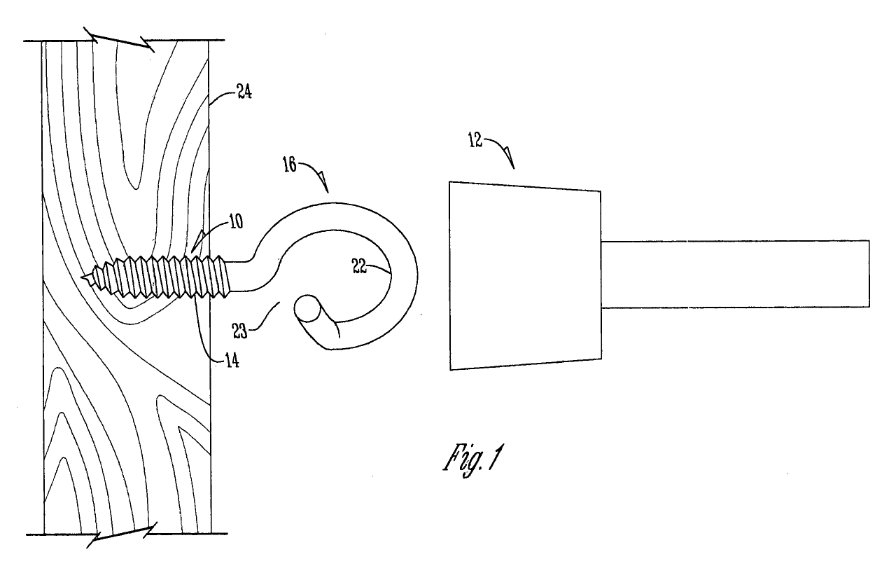

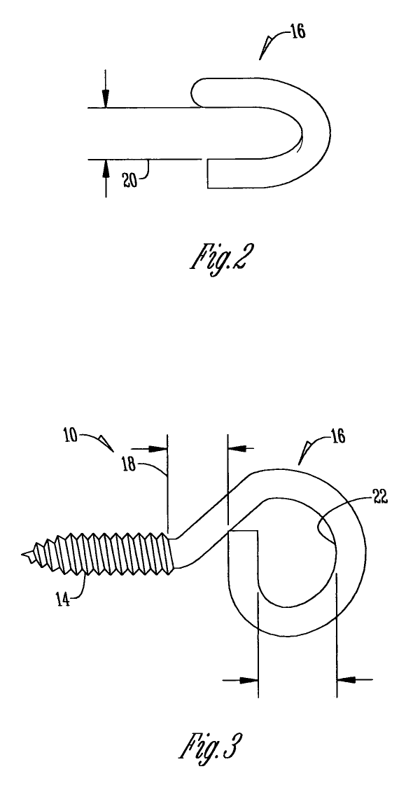

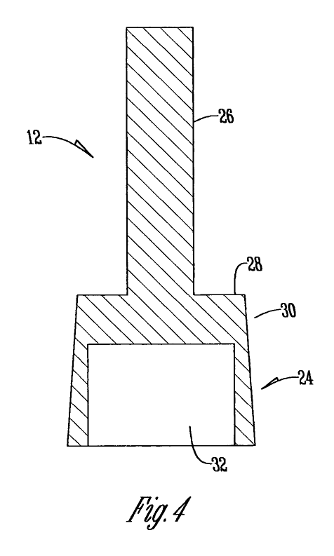

FIG. 1 shows a barbed wire fastener 10 and driving mechanism 12. The fastener 10 has an elongated threaded shank or body 14 that terminates in a helically shaped eye portion 16. The eye portion 16 is bent at a 45 degree angle from the center axis of the shank 14 to help regulate the installation screw depth and keep the barbed wire close to the fence post. As best seen in FIGS. 2-3 the eye portion has a first gap 18 between the body 14 and the eye portion 16 and a second gap 20 of the interior diameter of the eye portion 16 that are greater than or equal to the diameter of the barbed wire so that the barbed wire may be inserted into the eye 22 of the fastener 10. Furthermore, a clearance 23 for receiving barbed wire is formed between the end of the eye portion 16 and the transition from the body 14 and the eye portion 16.

FIG. 4 shows a sectional view of the driving mechanism 12. The driving mechanism 12 has a head portion 24 that is specially designed to receive the barbed wire fastener 10. The head 24 preferably is frusto-conically shaped and has an elongated shaft or shank 26 extending therefrom. The elongated shaft 26 is designed to fit within a cordless power drill chuck such that the drill will be able to secure the elongated shaft and turn the driving mechanism 12. The head 24 is formed by an annular shoulder 28 that extends outwardly from the elongated shaft 26 to side wall 30. The side wall 30 forms a slotted recess or cavity 32 that is specifically shaped to receive the helically shaped eye portion 16 of the barbed wire fastener 10. In an alternative embodiment the slot or cavity is profiled to the shape of the fastener 10 such that the threaded shank of the fastener and the shank of the driver would align on the same center line. This reduces the wobble present with misalignment. Additionally, the driver head can be magnetized to provide a stronger hold on the fastener.

In operation, when installing barbed wire with the present invention, a hole is pre drilled into a fence post. Then an individual places the driving mechanism 12 into a power tool and places the helically shaped eye portion 16 into the cavity 32 of the driving mechanism 12 and twists the fastener 10 into the fence post. Next, the driving mechanism is removed from the eye portion 16, and barbed wire is inserted into the eye 22 of the helically shaped barbed wire fastener 10 to secure the barbed wire to the fastener. Preferred is that the clearance 23 is positioned upward, or at a 12 o'clock position for insertion of the wire. Then the driving mechanism 12 is placed back onto the eye portion 16 of the fastener 10 and used to tighten the barbed wire by turning the fastener 10 and locking the barbed wire in place.

One skilled in the art will appreciate that a gap 18 must exist between the eye portion 16 of the fastener and the fence post when the fastener 10 is installed to the horizontal position. The width of this gap 18 needs to be equal to at least the diameter of the wire that the fastener 10 is intended to hold. Any excess gap is undesirable. Furthermore, simply having the eye 22 of the fastener 10 extended out from the post is undesirable as the fastener will not fully be installed. Likewise, the second gap 20 in the eye portion 16 needs to be equal to or at least the diameter of the wire it is intended to hold and any excess gap is undesirable. The helical shape of the eye portion 16 creates a clearance 23 in the eye 22 of the fastener 10 which also needs to be equal to at least the diameter of the wire it is intended to hold. Any excess clearance is undesirable. When the fastener is turned to the vertical position the eye portion 16 should be closed, or at least nearly closed, so that the wire cannot slide out of the eye portion 16. Thus, the first gap 16, the second gap 20, and the clearance 23 should be nearly equal to provide a taut barbed wire.

Additionally, one skilled in the art will understand that a constant diameter eye portion 16 would not provide a first gap 18 unless the eye portion 16 was truncated with a straight section. This fastener would meet the criteria listed above; however, this eye portion method would allow for excess vertical movement of the wire which is undesirable. A conical or helically shaped eye portion 16 reduces the excess vertical movement and requires a less pronounced straight section to close the coil when in the vertical position. Therefore, the fastener of the present invention allows for a barbed wire to be locked in place using a force greater than that of a conventional staple.

The helical shape of the eye portion creates the first and second gaps and clearance of relatively similar distances to allow the wire to be locked in place and to allow the barbed wire to be properly tightened. Additionally, by having the 45 degree bend from the threaded shank the installation screw in-depth can be regulated, and furthermore, the barbed wire is kept close to the fence post. Additionally, because of the helical shape, wire is able to be inserted into the eye of the fastener and the fastener is able to lock the wire into place without having the fastener back out of the fence post. One skilled in the art will also appreciate that if one were to have a left hand eye portion direction the fastener could be tightened an additional amount when locking the wire into place without loosening the fastener. Finally, because of the driving mechanism, a power tool can be used to facilitate the installation of the fastener and barbed wire to a fence post. Thus, for at least these reasons, all of the stated objectives have been met.

It will be appreciated by those skilled in the art that other various modifications could be made to the device without the parting from the spirit in scope of this invention. All such modifications and changes fall within the scope of the claims and are intended to be covered thereby.

1. A fastener for a barbed wire fence comprising:
a threaded shank; and a helically shaped eye portion.

2. The fastener of claim 1 wherein the shank has a center axis and the eye portion has an end that is bent at a 45 degree angle from the center axis.

3. The fastener of claim 1 wherein a first gap is created between the threaded shank and the helically shaped eye portion.

4. The fastener of claim 3 wherein a second gap is created within the helically shaped eye portion.

5. A driver for a barbed wire fastener comprising:
an elongated shaft having a head portion with a cavity formed to receive a helically shaped eye portion of a fastener.

6. A method of installing barbed wire onto a fencepost, comprising the steps of:
driving a helical shaped barbed wire fastener into a fencepost with a driver;
inserting a strand of barbed wire into an eye of the helical shaped fastener; and
turning the fastener to lock the barbed wire in place.
